(19) United States
(12) Patent Application Publication
(10) Pub. No.: US 2015/0070377 A1
(43) Pub. Date: Mar. 12, 2015

(54) IMAGE SIGNAL PROCESSING CIRCUIT, IMAGE SIGNAL PROCESSING METHOD AND DISPLAY APPARATUS

(71) Applicant: Sony Corporation, Tokyo (JP)

(72) Inventor: Kazuhisa Matsui, Tokyo (JP)

(73) Assignee: Sony Corporation, Tokyo (JP)

(21) Appl. No.: 14/476,405

(22) Filed: Sep. 3, 2014

(30) Foreign Application Priority Data
Sep. 12, 2013 (JP) 2013-189690

(51) Int. Cl. G06T 5/00; G06T 11/00

(52) U.S. Cl. CPC G06T 5/009; G06T 11/001; G06T 2207/10024
USPC 345/589

(57) ABSTRACT

An image signal processing circuit includes a storage unit that stores a number of set values, which determine correction values for performing correction of color temperature of an input digital image signal, that is less than a number of gradations, and a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

### CROSS REFERENCE TO RELATED APPLICATIONS

This application claims the benefit of Japanese Priority Patent Application JP 2013-189690 filed Sep. 12, 2013, the entire contents of which are incorporated herein by reference.

### BACKGROUND

The present disclosure relates to an image signal processing circuit, an image signal processing method and a display apparatus.

In recent years in the field of display apparatuses, flat type (flat panel type) display apparatuses that are formed by pixels that include a light-emitting unit being disposed in matrix form, have become commonplace. In this kind of display apparatus in the related art, in order to reproduce an image that is close to a target color temperature (hue), display apparatuses are configured such that correction values for all gradations are prepared as a table for a digital image signal that is input, and color temperature correction is performed for each single gradation (for example, refer to Japanese Unexamined Patent Application Publication No. 11-296149).

### SUMMARY

However, in the related art that is disclosed in Japanese Unexamined Patent Application Publication No. 11-296149, since it was necessary to store correction values in advance for all gradations as a table for a digital image signal that is input, the scale of the circuit becomes larger.

In such an instance, in the present disclosure, it is desirable to provide an image signal processing circuit and an image signal processing method in which it is possible to perform correction of color temperature on all gradations while controlling the scale of the circuit, and a display apparatus that has the image signal processing circuit (or that uses the image signal processing method).

According to an embodiment of the present disclosure, there is provided an image signal processing circuit that includes a storage unit that stores a number of set values, which determine correction values for performing correction of color temperature of an input digital image signal, that is less than a number of gradations, and a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

In addition, according to another embodiment of the present disclosure, there is provided an image signal processing method that includes storing a number of set values, which determine correction values for performing correction of color temperature of an input digital image signal, that is less than a number of gradations in a storage unit, and calculating correction values for performing the correction of color temperature on the basis of the set values for gradations for which a set value is stored in the storage unit, and on the basis of post-correction gradation values of gradations for which a set value is stored for gradations for which a set value is not stored in the storage unit.

In addition, according to still another embodiment of the present disclosure, there is provided a display apparatus that includes a pixel array unit that is formed by arranging pixels that include light-emitting units, and an image signal processing circuit that supplies an image signal that drives the light-emitting unit of each pixel of the pixel array unit, in which the image signal processing circuit is provided with a storage unit that stores a number of set values, which determine correction values for performing correction of color temperature of an input digital image signal, that is less than a number of gradations, and a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

In an image signal processing circuit, an image signal processing method and a display apparatus with the abovementioned configurations, by calculating gradations for which a set value is not stored in the storage unit on the basis of post-correction gradation values of gradations for which a set value is stored, it is possible to perform the correction of color temperature of all gradations without having to store set values in the storage unit for all gradations. In this instance, “color temperature” assumes that radiation in a visible range of an object is black-body radiation, and refers to a temperature (a parameter that is displayed at the absolute temperature) that is estimated from the color of such radiation.

According to the embodiments of the present disclosure, since it is not necessary to store set values in the storage unit for all gradations, it is possible to perform the correction of color temperature of all gradations while suppressing the scale of the circuit.

Additionally, the effect of the embodiments of the present disclosure is not necessarily limited to the effect disclosed here, and may be any of the effects that are disclosed in the present specification. In addition, the effects that are disclosed in the present specification are merely examples, the present disclosure is not limited thereto and additional effects are possible.

### BRIEF DESCRIPTION OF THE DRAWINGS

FIG. 1 is a block diagram that shows an example of a configuration of an image data processing unit that includes an image signal processing circuit of the present disclosure, according to an embodiment;

FIG. 2 is a block diagram that shows an example of a configuration of a gamma adjustment unit, which is the image signal processing circuit of the present disclosure, according to an embodiment;

FIG. 3A is a diagram that shows input and output properties of RGB after correction in a low gradation portion, and FIG. 3B is a diagram that shows post-correction gradation values for each gradation for which a set value is stored in a set value storage register;

FIG. 4A is a diagram that shows a relationship between each set value of RGB that is stored in the set value storage register, and FIG. 4B is a diagram that shows an example of each set value of RGB;

FIG. 5 is a diagram that shows input and output properties when the correction of color temperature is not performed;

FIG. 6 is a diagram that shows input and output properties when the correction of color temperature is performed using straight-line interpolation;

FIG. 7 is an explanatory diagram of parameters that are used in the calculation of the correction values using straight-line interpolation;

FIG. 8A is a diagram that defines input data numbers X_{w}, FIG. 8B is a diagram that defines output initial reference values, output terminal reference values, register setting initial points and register setting terminal points, and FIG. 8C is a diagram that defines an input initial point;

FIG. 9 is a diagram that shows a method of interpolation in which a curved interpolation method such as spline interpolation is added to a straight-line interpolation method;

FIG. 10A is a diagram that shows input and output properties of RGB after correction in a low gradation portion, and FIG. 10B is a diagram that shows gradation and color temperature properties before correction and after correction;

FIG. 11 is a system configuration diagram that shows an outline of a basic configuration of a display apparatus of the present disclosure; and

FIG. 12 is a circuit diagram that shows an example of a specific circuit configuration of a pixel (a pixel circuit).

### DETAILED DESCRIPTION OF EMBODIMENTS

Hereinafter, embodiments for implementing the technology of the present disclosure (hereinafter, referred to as “embodiments”) will be described in detail using the drawings. The present disclosure is not limited to the embodiments, and the various numerical values and the like in the embodiments are examples. In the following description, like components and components that have the same function will be given the same symbols, and overlapping descriptions will be omitted. Additionally, the description will be given in the following order.

1. Overall Description relating to the Image Signal Processing Circuit, Image Signal Processing Method and Display Apparatus of Present Disclosure

### 2. Description of Embodiments

### 3. Display Apparatus of Present Disclosure

### Overall Description Relating to the Image Signal Processing Circuit, Image Signal Processing Method and Display Apparatus of Present Disclosure

In the image signal processing circuit and the image signal processing method of the present disclosure, it is possible to adopt a configuration that calculates the correction values of gradations for which a set value is not stored in the storage unit on the basis of post-correction gradation values of gradations that are in the vicinity of the gradations. At this time, it is possible to adopt a configuration that calculates the correction values of gradations for which a set value is not stored in the storage unit using straight-line interpolation from the post-correction gradation values of gradations that are in the vicinity of the gradations.

In an image signal processing circuit and an image signal processing method of the present disclosure that include the abovementioned preferable configuration, it is possible to adopt a configuration that stores the set values of the gradations of a relatively low gradation portion in the storage unit. In addition, it is possible to adopt a configuration in which, in a pitch between gradations for which a set value is stored in the storage unit, a low gradation side is narrower than a high gradation side. In addition, it is possible to adopt a configuration in which, in the gradations that correct the color temperatures, there are fewer green (G) digital image signals than red (R) and blue (B) digital image signals. It is possible to adopt a configuration that performs the correction of color temperature by adding a calculated correction value to a signal value of a digital image signal.

The display apparatus of the present disclosure is a flat surface type (a flat panel type) display apparatus that is formed by arranging pixels (pixel circuits) that include light-emitting units. Examples of flat surface type display apparatuses include organic EL display apparatuses, liquid crystal display apparatuses, plasma display apparatuses and the like. Among these display apparatuses, organic EL display apparatuses use an organic electroluminescence element (hereinafter, referred to as an “organic EL element”) that uses the electroluminescence of an organic material, and makes use of a phenomenon in which light is emitted when an electrical field is applied to an organic thin film, as a light emitting element (an electro-optical element) of a pixel.

Organic EL display apparatuses that use organic EL elements as the light-emitting unit of a pixel have the following characteristics. That is, since it is possible for organic EL elements to be driven with an application voltage of less than or equal to 10 V, organic EL display apparatuses have low power consumption. Since organic EL elements are self-luminous type elements, the visibility of the images in organic EL display apparatuses is high in comparison with liquid crystal display apparatuses, which are also flat type display apparatuses, and additionally, since an illumination member such as a backlight is not necessary, weight saving and thinning are easy. Furthermore, since the response speed of organic EL elements is extremely fast to the extent of approximately a few microseconds, organic EL display apparatuses do not generate a residual image during video display.

In addition to being self-luminous type elements, the organic EL elements that configure the light-emitting units are current drive type electro-optical elements in which the brightness of light emission changes depending on a current value that flows to the device. In addition to organic EL elements, examples of current drive type electro-optical elements include inorganic EL elements, LED elements, semiconductor laser elements and the like.

Flat type display apparatuses such as organic EL display apparatuses can be used as a display unit (display apparatus) in various electronic apparatuses that are provided with a display unit. Examples of the various electronic apparatuses include head-mounted displays, digital cameras, video cameras, game consoles, notebook personal computers, portable information devices such as e-readers, mobile communication units such as Personal Digital Assistants (PDAs) and cellular phones.

In a display apparatus of the present disclosure that includes the abovementioned preferable configuration, it is possible to adopt a configuration in which the pixels are formed from a combination of organic EL elements that emit white light and color filters. In addition, it is possible to adopt a configuration in which each pixel of the pixel array unit is formed on a semiconductor. At this time, it is possible to adopt a configuration in which the image signal processing circuit is also formed on the semiconductor along with each pixel of the pixel array unit. In addition, it is possible to adopt a configuration in which the set values for determining the correction values are set for each display apparatus.

### DESCRIPTION OF EMBODIMENTS

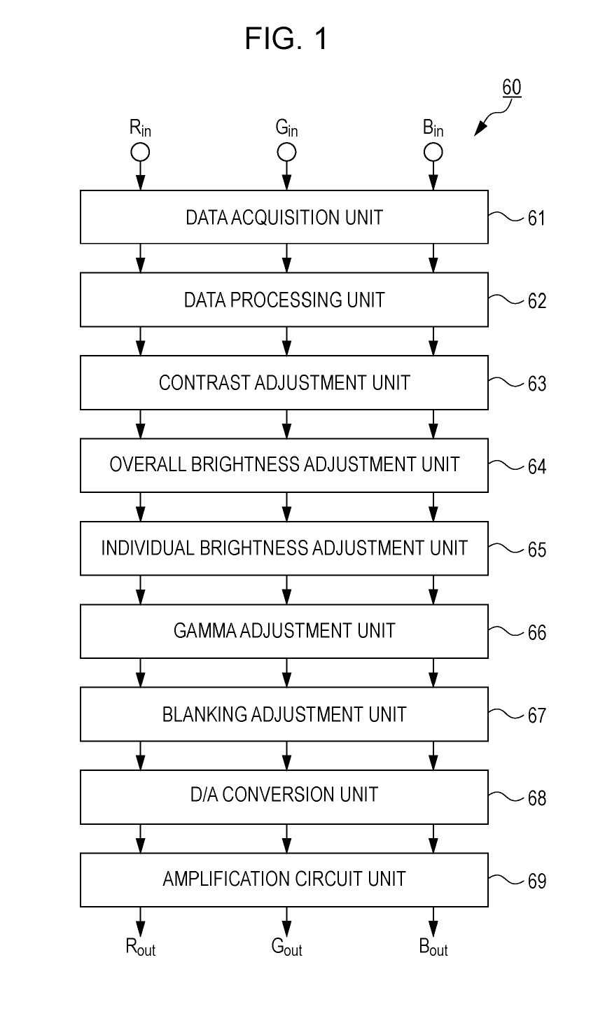

FIG. 1 is a block diagram that shows an example of a configuration of an image data processing unit according to an embodiment that includes the image signal processing circuit of the present disclosure. In this instance, a digital image signal that is input as a target for processing is set as an 8-bit digital image signal of each of R (red), G (green) and B (blue) as an example.

As shown in FIG. 1, an image data processing unit 60 according to the present embodiment has a configuration that includes a data acquisition unit 61, a data processing unit 62, a contrast adjustment unit 63, an overall brightness adjustment unit 64, an individual brightness adjustment unit 65, a gamma adjustment unit 66, a blanking adjustment unit 67, a D/A conversion unit 68 and an amplification circuit unit 69.

In the image data processing unit 60 that has the abovementioned configuration, each 8-bit digital image signal Rᵢₙ, Gᵢₙ and Bᵢₙ of RGB that is acquired by the data acquisition unit 61 is supplied to the contrast adjustment unit 63 as for example, a 10-bit digital image signal after predetermined processes have been performed in the data processing unit 62. The adjustment of contrast, which is a ratio of a maximum brightness and a minimum brightness, is performed in the contrast adjustment unit 63. The adjustment of brightness is performed overall for RGB in the overall brightness adjustment unit 64 on a digital image signal that has passed the contrast adjustment unit 63, and subsequently the adjustment of brightness is performed individually for RGB in the individual brightness adjustment unit 65. Thereafter, the digital image signal is supplied to the gamma adjustment unit 66.

The gamma adjustment unit 66 is a color temperature correction unit that performs the correction of color temperature by performing level adjustment for each color of the RGB digital image signal, and corresponds to the image signal processing circuit of the present disclosure. In a color display apparatus, the repeatability of colors differs in each display apparatus (display panel) depending on the properties thereof. The gamma adjustment unit 66 adjusts a blend ratio of RGB, and performs the correction of color temperature in order to reproduce an image that is close to a desired color temperature (hue). The gamma adjustment unit 66 that performs the correction of color temperature will be described in detail later.

A digital image signal on which the correction of color temperature has been performed in the gamma adjustment unit 66 is supplied to the blanking adjustment unit 67. Processes such as deciding whether to set data that is outside an effective display area of the display apparatus to black data, or to data of a specific gradation are performed in the blanking adjustment unit 67. A digital image signal that has passed the blanking adjustment unit 67 output as RGB analog image signals Rₒᵤₜ, Gₒᵤₜ and Bₒᵤₜ through the amplification circuit unit 69 after being converted to an analog signal in the D/A conversion unit 68.

The analog image signals Rₒᵤₜ, Gₒᵤₜ and Bₒᵤₜ that are output from the image data processing unit 60 are supplied to a pixel array unit of a display panel (display apparatus) that is formed by arranging RGB pixels that include light-emitting units in row and column form (matrix form). More specifically, the analog image signals Rₒᵤₜ, Gₒᵤₜ and Bₒᵤₜ that are output from the image data processing unit 60 are supplied in pixel row units to each pixel of the pixel array unit through a signal line that is wired for each RGB pixel row (this will be described in more detail later).

### Image Signal Processing Circuit of Present Disclosure

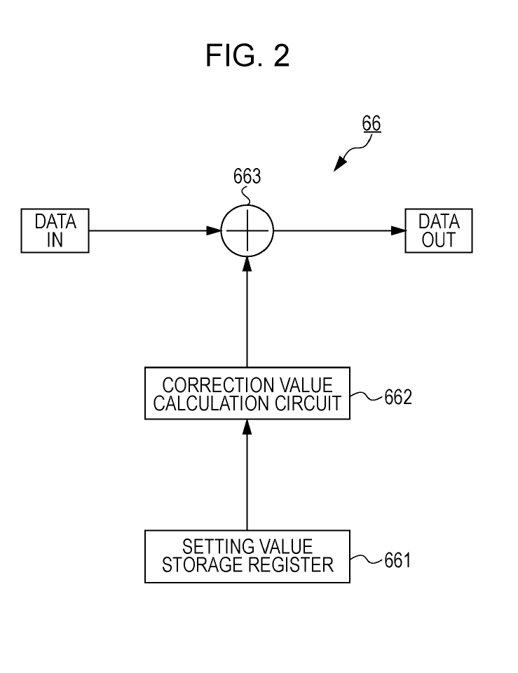

Next, the gamma adjustment unit 66 that performs the correction of color temperature will be specifically described. FIG. 2 is a block diagram that shows an example of a configuration of the gamma adjustment unit 66, which is the image signal processing circuit of the present disclosure, according to an embodiment. In this instance, a circuit portion of the gamma adjustment unit 66 that corresponds to 1 color of the RGB digital image signal is represented.

As shown in FIG. 2, the gamma adjustment unit 66 according to the present embodiment has a configuration that is formed from a set value storage register 661, which is an example of a storage unit, a correction value calculation circuit 662, which is an example of a computation unit, and an adder 663. The adder 663 configures the computation unit along with the correction value calculation circuit 662.

The set value storage register 661 stores a number of set values, which determine the correction values for performing the correction of color temperature of an input digital image signal, that is less than the number of gradations of the digital image signal. As an example, in a case in which the digital image signal is a 10-bit digital image signal, the set value storage register 661 stores set values of the five gradations of 32 gradations, 64 gradations, 128 gradations, 256 gradations and 320 gradations for a low gradation portion (a low brightness portion) of relatively low gradations (for example, 0 gradations to 320 gradations).

As described above, the repeatability of the colors of a color display apparatus differs in each display apparatus (display panel) depending on the properties thereof. Therefore, in the set value storage register 661, set values are stored in each display apparatus (display panel) depending on the properties thereof. For example, in an organic EL display apparatus in which the light-emitting units of the pixels are formed from organic EL elements, since the organic EL elements show device-specific non-linear optical response properties with respect to a drive voltage, the set values that are stored in the set value storage register 661 are set by being matched with the optical response properties in each display apparatus (display panel).

The correction value calculation circuit 662, which is an example of the computation unit, calculates correction values for performing the correction of color temperature on the basis of the set values for gradations for which a set value is stored in the set value storage register 661.

In the present example, since the set values of 32 gradations, 64 gradations, 128 gradations, 256 gradations and 320 gradations are stored in the set value storage register 661, the correction value calculation circuit 662 calculates correction values of each gradation on the basis of corresponding set values that are stored in the set value storage register 661.

In addition, the correction value calculation circuit 662 performs calculation for gradations for which a set value is not stored in the set value storage register 661 on the basis of post-correction gradation values of gradations for which set values that are stored. More specifically, the correction value calculation circuit 662 calculates the gradation values of gradations for which a set value is not stored in the set value storage register 661 on the basis of post-correction gradation values of gradations that are in the vicinity of the gradations (32 gradations, 64 gradations, 128 gradations, 256 gradations and 320 gradations) using straight-line interpolation (linear interpolation), for example. Therefore, for gradations for which a set value is not stored in the set value storage register 661, the correction value calculation circuit 662 calculates (the output value (gradation value) of the adder 663−the signal value of the digital image signal) as a correction value.

Further, the correction of color temperature is performed by the adder 663 adding the correction values that are calculated by the correction value calculation circuit 662 to the signal values of the digital image signal, and ultimately, the gradation values of each gradation are determined.

### Calculation of Correction Values

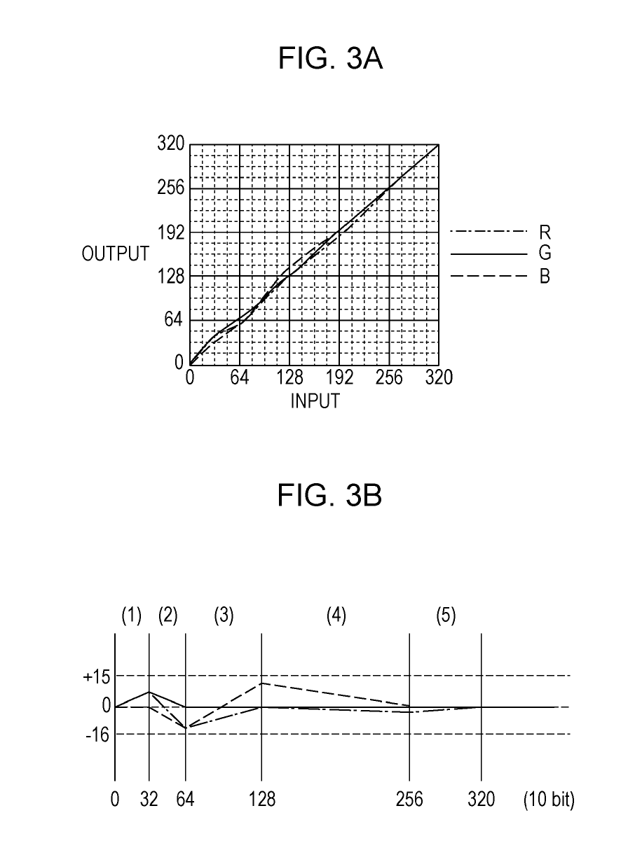

Hereinafter, the calculation of correction values in the correction value calculation circuit 662 will be described. FIG. 3A shows input and output properties of RGB after correction in a low gradation portion. In FIG. 3A, the long dashed short dashed line represents the input and output properties of R, the solid line represents the input and output properties of G, and the dashed line represents the input and output properties of B. In addition, FIG. 3B shows post-correction gradation values for each gradation for which a set value is stored in a set value storage register 661.

As shown in FIG. 3B, in the case of the present example, gradations for which a set value is stored in the set value storage register 661 are 32 gradations, 64 gradations, 128 gradations, 256 gradations and 320 gradations. Further, for example, fixed values of −16 to 0 to +15 are set as the set values that are stored in the set value storage register 661.

In FIG. 3B, a region (1) is a gradation region of a gradation 0 to a gradation 32 of a 10-bit value. In addition, a region (2) is a gradation region of the gradation 32 to a gradation 64, a region (3) is a gradation region of the gradation 64 to a gradation 128, a region (4) is a gradation region of the gradation 128 to a gradation 256, and a region (5) is a gradation region of the gradation 256 to a gradation 320. As can be clearly understood from FIG. 3B, each gradation for which a set value is stored in the set value storage register 661 is set so that in a pitch between gradations, a low gradation side is narrower than a high gradation side.

Set values for determining correction values for performing the correction of color temperature of an RGB digital image signal are stored in the set value storage register 661. In human visibility, among RGB, visibility of green is the highest (strongest). Therefore, when performing the correction of color temperature, a process of setting the input and output properties of G as a standard, and making the input and output properties of RB match these input and output properties, is performed. Further, for gradations for which the color temperature is corrected, fewer G, which is a standard, gradations are set than RB gradation. As an example, as shown in FIG. 3B, a configuration in which the correction of G, which is a standard, is not performed in region (3) to region (5), can be used.

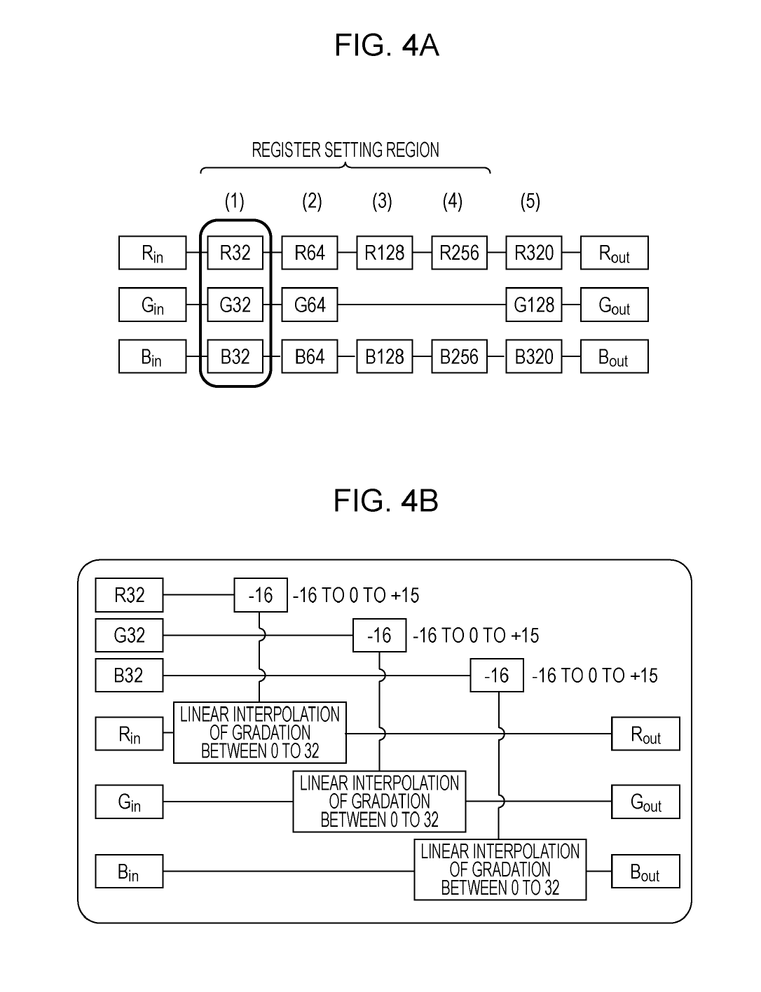

More specifically, as shown in FIG. 4A, for R, each set value R32, R64, R128, R256 and R320 of 32 gradations, 64 gradations, 128 gradations, 256 gradations and 320 gradations is stored in the set value storage register 661. In the same manner, for B, each set value B32, B64, B128, B256 and B320 is also stored in the set value storage register 661. In contrast to this, for G, each set value G32 and G64 of 32 gradations and 64 gradations, and a set value G128 of 128 gradations and 256 gradations to 320 gradations are stored in the set value storage register 661.

In this instance, as one example, a case in which, as shown in FIG. 4B, among the fixed values of −16 to 0 to +15, each set value R32, G32 and B32 of 32 gradations is set to −16, is given as an example. In this case, correction values that correspond to R32=−16, G32=−16 and B32=−16 are calculated by the correction value calculation circuit 662 for each color of 32 gradations of RGB. Meanwhile, for each gradation of the gradation region (1) of 0 to 32 gradations, each post-correction gradation value of 0 gradations and 32 gradations is connected by a straight line (a linear function), and the gradation values of each gradation are calculated by the correction value calculation circuit 662 using straight-line interpolation.

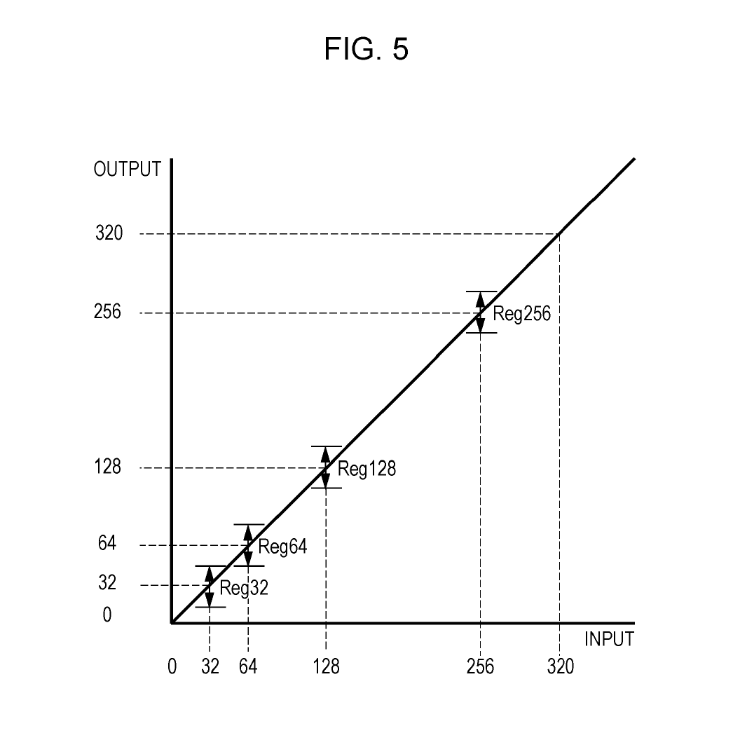

The calculation of the correction values will be described more specifically. Hereinafter, the calculation will be described as a process that is common to each color of RGB. Therefore, each set value of 32 gradations, 64 gradations, 128 gradations and 256 gradations that are stored in the set value storage register 661 is given the term Reg32, Reg64, Reg128 and Reg256. The correction of color temperature is not performed when Reg32=0, Reg64=0, Reg128=0 and Reg256=0. The input and output properties at this time are a straight line as shown in FIG. 5.

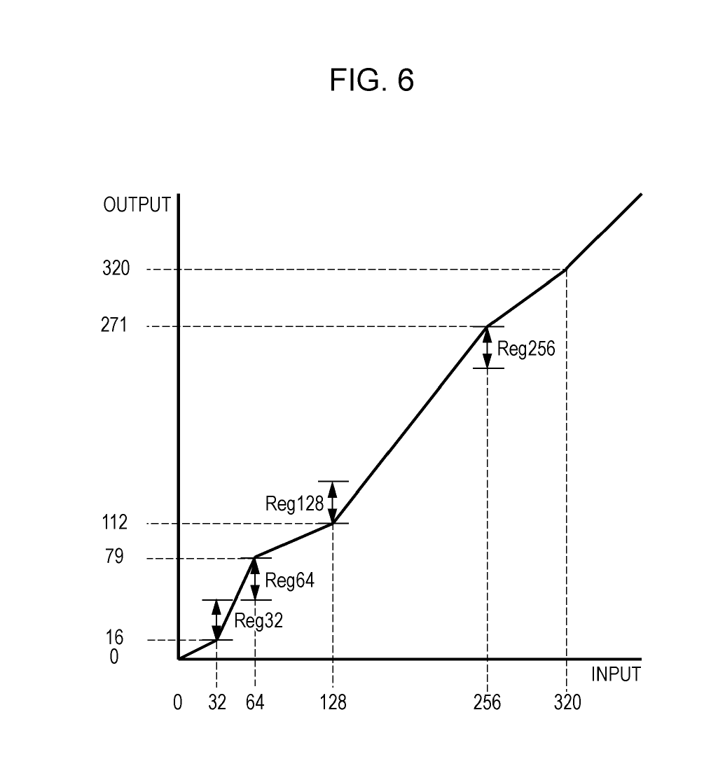

In a case in which the correction of color temperature is performed, the Reg32, Reg64, Reg128 and Reg256 are stored in the set value storage register 661. As an example, a configuration in which Reg32=−16, Reg64=+15, Reg128=−16 and Reg256=+15 are set as the set values is used. At this time, the correction values of each gradation are calculated on the basis of these set values, and the correction of color temperature is performed on the basis of the calculated correction values. For gradations that are between the gradations for which a set value is stored, the correction values of each gradation are calculated using straight-line interpolation, and the correction of color temperature is performed on the basis of the calculated correction values. As shown in FIG. 6, the input and output properties at this time form a broken line with the post-correction gradation values of each gradation for which a set value is stored in the set value storage register 661 as break points thereof.

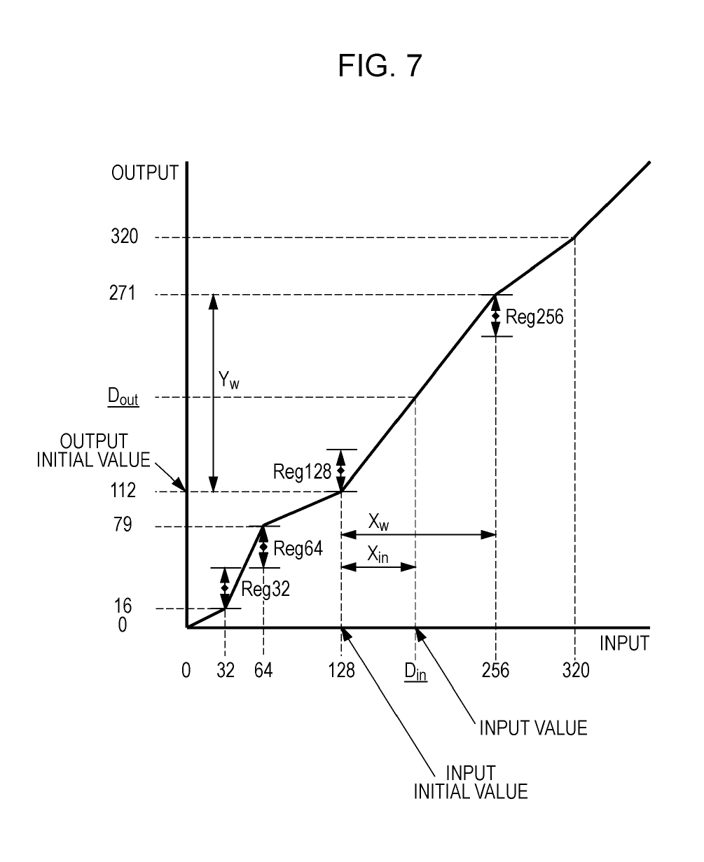

Next, the calculation of the correction values using straight-line interpolation will be described more specifically. The description will be given using a case of calculating a gradation value (an output value) Dₒᵤₜ of a gradation (an input value) Dᵢₙ that is between the gradation 128 and the gradation 256 in FIG. 7, as an example. In this case, the gradation 128 is an input initial value, and a post-correction gradation value 112 of the gradation 128 is an output initial value. In addition, a difference between the gradation 256 and the gradation 128 is an input data number X_{w}, and a difference between a post-correction gradation value 271 of the gradation 256 and a post-correction gradation value 112 of the gradation 128 is an output difference Y_{w}. Further, by setting the abovementioned input value Dᵢₙ, the input initial value, the output initial value, the input data number X_{w} and the output difference Y_{w} as parameters, it is possible to calculate the gradation value of the input value Dᵢₙ, that is, an output value Dₒᵤₜ on the basis of the following formula (1).

output value Dₒᵤₜ=inclination×(input value Dᵢₙ−input initial value)+output initial value (1)

In this instance, the inclination is the inclination of a straight line that connects the post-correction gradation value 112 of the gradation 128 and the post-correction gradation value 271 of the gradation 256, and it is possible to calculate the inclination using output difference Y_{w}/input data number X_{w}. In addition, the output difference Y_{w} is given by the following formula (2).

output difference Y_{w}=output terminal value−output initial value=(output terminal reference value+register setting terminal point)−(output initial reference value+register setting initial point) (2)

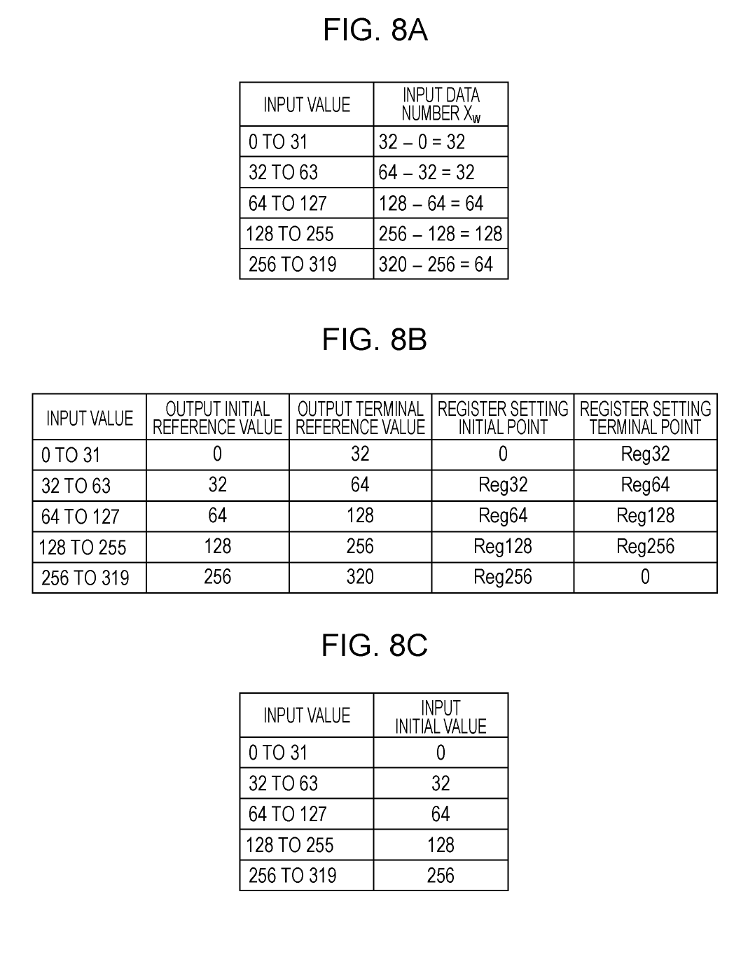

FIG. 8A defines input data numbers X_{w}, and FIG. 8B defines output initial reference values, output terminal reference values, register setting initial points and register setting terminal points, and FIG. 8C defines input initial points. As shown in FIG. 8A, the input data number X_{w} is set as 32 (=32−0) at input values 0 to 31, set as 32 (=64−32) at input values 32 to 63, set as 64 (=128−64) at input values 64 to 127, set as 128 (=256−128) at input values 128 to 255, and set as 64 (=320−256) at input values 256 to 319.

As shown in FIG. 8B, the output initial reference value, the output terminal reference value, the register setting initial point and the register setting terminal point are set as 0, 32, 0 and Reg32 at input values 0 to 31, and set as 32, 64, Reg32 and Reg64 at input values 32 to 63. In addition, the abovementioned parameters are set as 64, 128, Reg64 and Reg128 at input values 64 to 127, set as 128, 256, Reg128 and Reg256 at input values 128 to 255, and set as 256, 320, Reg256 and 0 at input values 256 to 319. As shown in FIG. 8C, the input initial point is set as 0 at input values 0 to 31, set as 32 at input values 32 to 63, set as 64 at input values 64 to 127, set as 128 at input values 128 to 255, and set as 256 at input values 256 to 319.

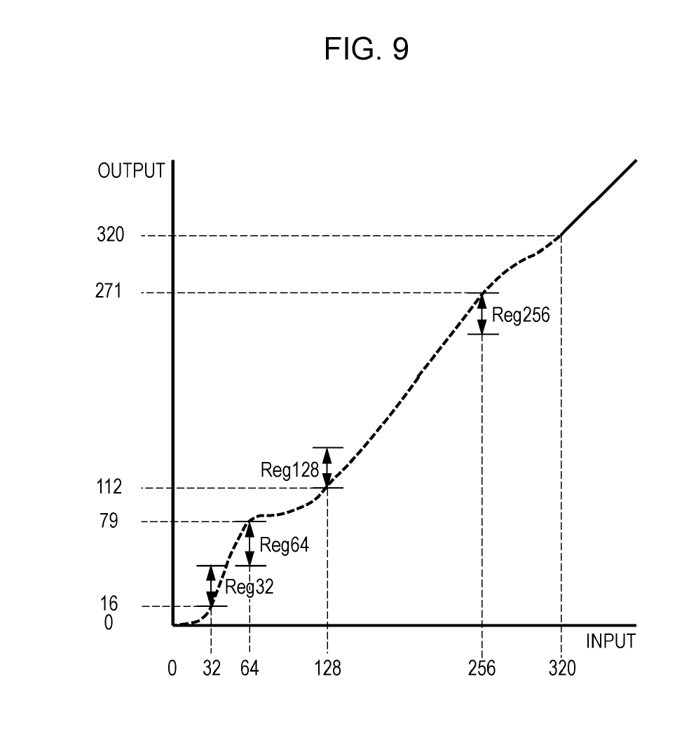

Additionally, in the abovementioned calculation of correction values using the correction value calculation circuit 662, a configuration in which gradations for which a set value is not stored in the set value storage register 661 were calculated using a straight-line interpolation method was used, but this is not limited thereto. For example, as shown in FIG. 9, it is also possible to use a method of interpolation in which a curved interpolation method such as spline interpolation is added to a straight-line interpolation method.

In the abovementioned manner, in the present embodiment, color temperature correction for gradations for which a set value is not stored in the set value storage register 661 is performed by calculating correction values using straight-line interpolation on the basis of post-correction gradation values of gradations that are in the vicinity of the gradations. This kind of color temperature correction is a kind of color temperature correction in which the input and output properties form a broken line with the post-correction gradation values of each gradation for which a set value is stored in the set value storage register 661 as break points thereof.

According to this color temperature correction in which the input and output properties form a broken line, it is also possible to perform the correction of gradations for which a set value is not stored in the set value storage register 661. In other words, it is possible to perform color temperature correction on all gradations without having to store set values for all gradations in the set value storage register 661. Therefore, in comparison with a case that stores set values for all gradations in a look-up table or the like, of a storage unit, it is possible to perform the correction of color temperature on all gradations while suppressing the scale of the circuit.

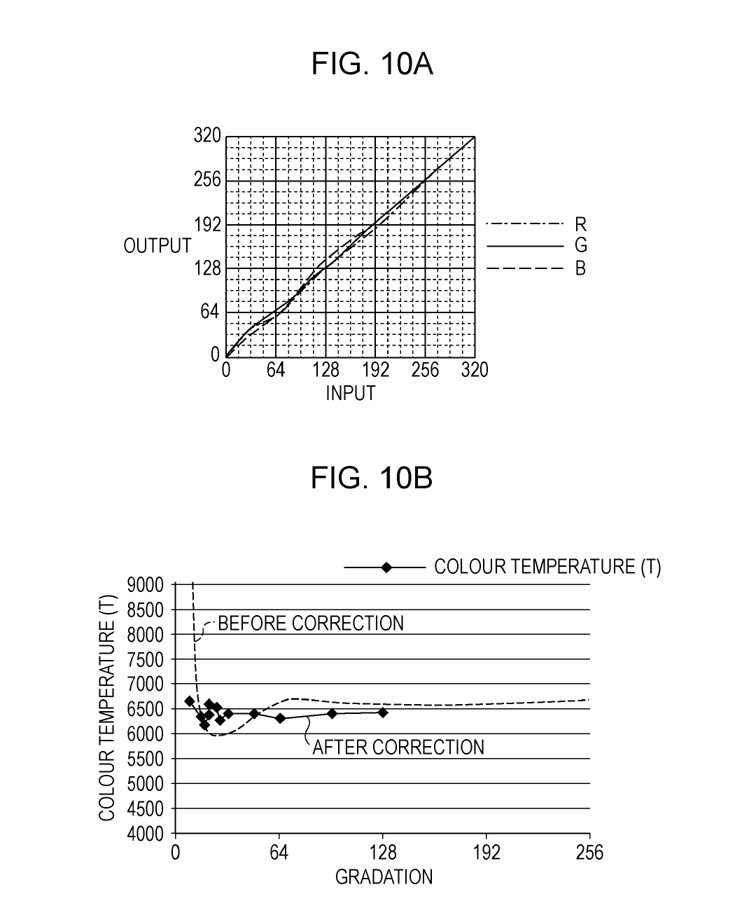

In particular, by setting so that a low gradation side in a pitch between gradations, is narrower than a high gradation side, in addition to storing set values of gradations of a relatively low gradation portion in the set value storage register 661, it is even possible to reliably perform the correction of color temperature during low gradations when the I-V properties (current−voltage) of the light-emitting unit, which is a target for driving, are non-linear. FIG. 10A shows input and output properties of RGB in a low gradation portion, and FIG. 10B shows gradation and color temperature properties before correction and after correction. In FIG. 10A, the long dashed short dashed line represents the input and output properties of R, the solid line represents the input and output properties of G, and the dashed line represents the input and output properties of B. In addition, in FIG. 10B, the dashed line represents the gradation and color temperature properties before correction and the solid line represents gradation and color temperature properties after correction.

Display Apparatus of Present Disclosure System Configuration

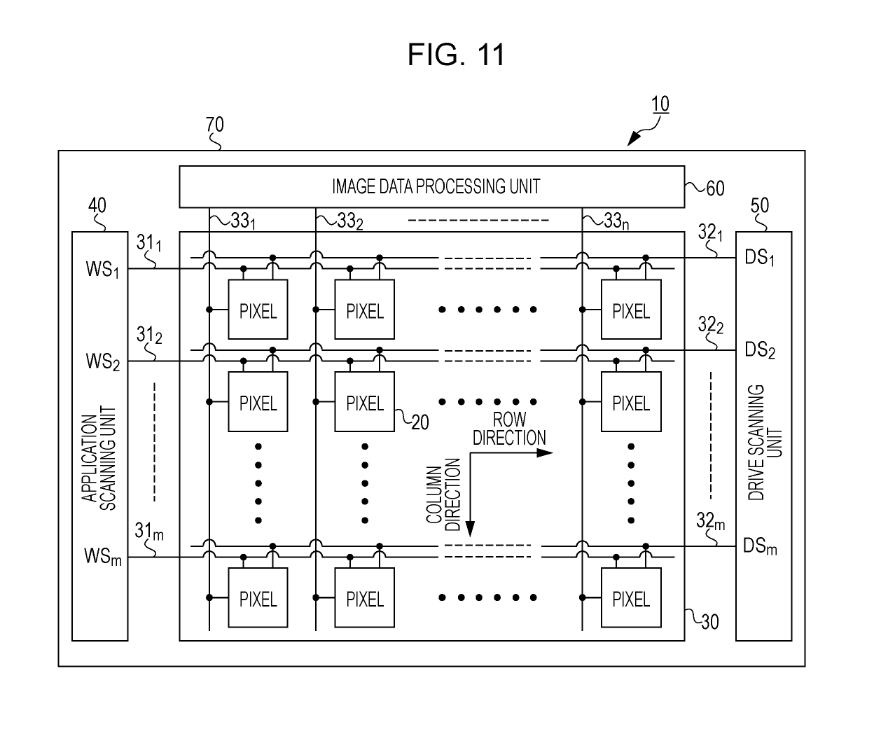

FIG. 11 is a system configuration diagram that shows an outline of a basic configuration of a display apparatus of the present disclosure. In this instance, an active matrix type display apparatus is shown as an example. The active matrix type display apparatus is a display apparatus that controls a current that flows to light-emitting units using an active element, for example, an insulated-gate field effect transistor, which is provided inside the same pixel circuit as the light-emitting units. Typically, it is possible to use a Thin Film Transistor (TFT) as an insulated-gate field effect transistor.

In this instance, a case of an active matrix type organic EL display apparatus that uses an organic EL element, which is a current drive type electro-optical element in which light emission brightness changes depending on a current value that flows in a device, for example, as a light-emitting unit (light emitting element) of a pixel circuit will be described as an example. Hereinafter, there are cases in which “pixel circuits” are simply referred to as “pixels”.

As shown in FIG. 11, a display apparatus (an organic EL display apparatus) 10 of the present disclosure has a configuration that includes a pixel array unit 30 that is formed by arranging a plurality of pixels 20, which include an organic EL element, two-dimensionally in matrix form, and a drive unit that is arranged in the periphery of the pixel array unit 30. The drive unit, for example, is formed by an application scanning unit 40 that is mounted on the same display panel 70 as the pixel array unit 30, a drive scanning unit 50, the image data processing unit 60 and the like, and drives each pixel 20 of the pixel array unit 30. Additionally, it is possible to adopt a configuration in which a number of or all of the application scanning unit 40, the drive scanning unit 50 and the image data processing unit 60 are provided outside the display panel 70.

In this instance, in a case in which the organic EL display apparatus 10 is capable of color display, a single pixel (unit pixel/pixel), which is a unit that forms a color image, is configured from a plurality of subpixels. In this case, each subpixel corresponds to the pixels 20 of FIG. 11. More specifically, in a display apparatus that is capable of color display, a single pixel is for example, configured from three subpixels of a subpixel that emits red (R) light, a subpixel that emits green (G) light and a subpixel that emits blue (B) light.

However, the present disclosure is not limited to a configuration of combining subpixels of the three primary colors of RGB as one pixel, and it is possible to configure a single pixel by further adding a subpixel of a color or subpixels of a plurality of colors to the subpixels of the three primary colors. More specifically, for example, it is possible to configure a single pixel by adding a subpixel that emits white (W) light for improving brightness, and it is also possible to configure a single pixel by adding at least one subpixel that emits complementary color light for expanding the color reproduction range.

Scanning lines 31 (31₁ to 31ₘ) and power supply lines 32 (32₁ to 32ₘ) are wired in the pixel array unit 30 along a row direction (an arrangement direction of the pixels of a pixel row/a horizontal direction) for each pixel row with respect to an arrangement of m rows and n columns of pixels 20. Furthermore, signal lines 33 (33₁ to 33ₙ) are wired along a column direction (an arrangement direction of the pixels of a pixel column/a vertical direction) for each pixel column with respect to an arrangement of m rows and n columns of pixels 20.

The scanning lines 31₁ to 31ₘ are respectively connected to output ends of corresponding rows of the application scanning unit 40. The power supply lines 32₁ to 32ₘ are respectively connected to output ends of corresponding rows of the drive scanning unit 50. The signal lines 33₁ to 33ₙ are respectively connected to output ends of corresponding columns of the image data processing unit 60.

The application scanning unit 40 is configured by a shift register circuit and the like. The application scanning unit 40 sequentially supplies application scanning signals WS (WS₁ to WSₘ) to the scanning lines 31 (31₁ to 31ₘ) during the application of a signal voltage of an image signal to each pixel 20 of the pixel array unit 30. As a result of this, so-called line sequential scanning that scans each pixel 20 of the pixel array unit 30 in order in units of rows is performed.

The drive scanning unit 50 is configured by a shift register circuit and the like in the same manner as the application scanning unit 40. The drive scanning unit 50 supplies power source potentials DS (DS₁ to DSₘ), which are capable of switching between a first power source potential V_{cc}_{_{—}}_{H} and a second power source potential V_{cc}_{_{—}}_{L}, that is lower than the first power source potential V_{cc}_{_{—}}_{H}, to the power supply lines 32 (32₁ to 32ₘ) in synchronization with the line sequential scanning of the application scanning unit 40. As will be described later, control of the light emission and non-light emission (extinguishing) of the pixels 20 is performed by the drive scanning unit 50 switching between the V_{cc}_{_{—}}_{H} and the V_{cc}_{_{—}}_{L} of the power source potentials DS.

The image data processing unit 60 performs D/A conversion after carrying out signal processes such as the correction of color temperature on a digital image signal that is input from the outside, and outputs an analog image signals that depends on brightness information. The analog image signals that are output from the image data processing unit 60 are applied to each pixel 20 of the pixel array unit 30 through the signal lines 33 (33₁ to 33ₙ) in units of pixel rows that are selected by the scanning of the application scanning unit 40. That is, the image data processing unit 60 adopts a line sequential application driving form that applies the analog image signals in units of rows (lines).

### Pixel Circuit

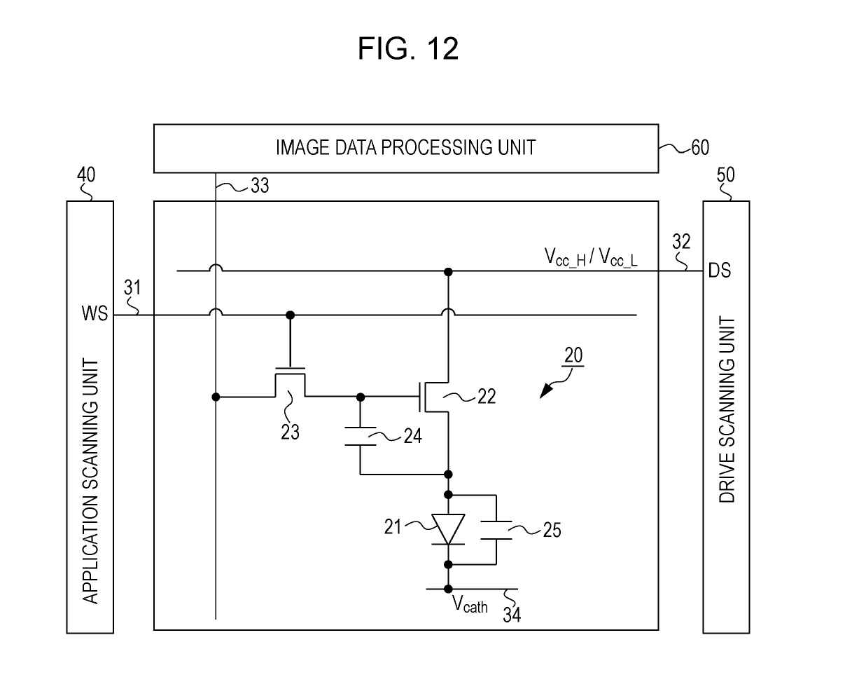

FIG. 12 is a circuit diagram that shows an example of a specific circuit configuration of a pixel (a pixel circuit) 20. The light-emitting unit of the pixel 20 is formed from an organic EL element 21, which is a current drive type electro-optical element in which light emission brightness changes depending on a current value that flows in a device.

As shown in FIG. 12, the pixel 20 is configured by the organic EL element 21, and a drive circuit that drives the organic EL element 21 by causing a current to flow to the organic EL element 21. In the organic EL element 21, a cathode electrode is connected to a common power supply line 34 that is commonly wired to all of the pixels 20.

The drive circuit that drives the organic EL element 21 has a configuration that includes a drive transistor 22, a sampling transistor 23, a storage capacitor 24 and an auxiliary capacitor 25. For example, an N-channel type TFT can be used as the drive transistor 22 and the sampling transistor 23. However, the conductive type combination of drive transistor 22 and a sampling transistor 23 that is illustrated here is merely an example, and the present disclosure is not limited to such a combination. That is, a P-channel type TFT can be used as either one of, or both the drive transistor 22 and the sampling transistor 23.

A first electrode (a source/drain electrode) of the drive transistor 22 is connected to an anode electrode of the organic EL element 21, and a second electrode (a source/drain electrode) thereof is connected to the power supply lines 32 (32₁ to 32ₘ). A first electrode (a source/drain electrode) of the sampling transistor 23 is connected to the signal lines 33 (33₁ to 33ₙ), and a second electrode (a source/drain electrode) thereof is connected to a gate electrode of the drive transistor 22. In addition, a gate electrode of the sampling transistor 23 is connected to the scanning lines 31 (31₁ to 31ₘ).

In the drive transistor 22 and the sampling transistor 23, a first electrode refers to metallic wiring that is electrically connected to a first source/drain region, and a second electrode refers to metallic wiring that is electrically connected to a second source/drain region. In addition, as a result of a potential relationship between the first and second electrodes, the first electrodes can become source electrodes or drain electrodes, and the second electrodes can become drain electrodes or source electrodes.

A first electrode of the storage capacitor 24 is connected to the gate electrode of the drive transistor 22, a second electrode thereof is connected to the second electrode of the drive transistor 22 and an anode electrode of the organic EL element 21. A first electrode of the auxiliary capacitor 25 is connected to an anode electrode of organic EL element 21, and a second electrode thereof is connected to a node with a fixed potential (in the present example, a cathode electrode of the common power supply line 34/organic EL element 21). The auxiliary capacitor 25 for example, offsets a shortage in capacity of the organic EL element 21, and is provided in order to improve application gain of the image signal to the storage capacitor 24. However, the auxiliary capacitor 25 is not a necessary component. That is, in a case in which it is not necessary to offset a shortage in capacity of the organic EL element 21, the auxiliary capacitor 25 is not necessary.

In a pixel 20 with the abovementioned configuration, the sampling transistor 23 is in a conductive state that responds to High active application scanning signals WS that are applied to the gate electrode thereof through the scanning lines 31 from the application scanning unit 40. As a result of this, the sampling transistor 23 samples analog image signals that depend on brightness information and are supplied through the signal lines 33 from the image data processing unit 60, and applies the analog image signals to the inside of the pixels 20. In addition to being applied to the gate electrode of the drive transistor 22, analog image signals that are applied by the sampling transistor 23 are stored in the storage capacitor 24.

When the power source potentials DS of the power supply lines 32 (32₁ to 32ₘ) are at the first power source potential V_{cc}_{_{—}}_{H}, the drive transistor 22 acts in a saturated region in which the first electrode is the drain electrode, and the second electrode thereof is the source electrode. As a result of this, the drive transistor 22 receives a supply of current from the power supply lines 32 and performs light-emission driving of the organic EL element 21 using current driving. Furthermore, when the power source potentials DS switch from the first power source potential V_{cc}_{_{—}}_{H} to the second power source potential V_{cc}_{_{—}}_{L}, the first electrode of the drive transistor 22 becomes the source electrode, the second electrode thereof becomes the drain electrode, and the drive transistor 22 acts as a switching transistor. As a result of this, the drive transistor 22 stops the supply of current to the organic EL element 21, and sets the organic EL element 21 to a non-light emission state. That is, the drive transistor 22 also has an additional function as a transistor that controls the light emission and non-light emission of the organic EL element 21 due to switching of the power source potentials DS (V_{cc}_{_{—}}_{H}/V_{cc}_{_{—}}_{L}).

As a result of the switching action of the drive transistor 22, a period (a non-light emission period) in which the organic EL element 21 attains a non-light emission state is provided, and it is possible to control a ratio (duty) of a light emission period and a non-light emission period of the organic EL element 21. As a result of this duty control, since it is possible to reduce residual image blur that accompanies the emission of light from the pixels during a single display frame period, it is possible to configure an organic EL element 21 with a superior video picture integrity. Among the first power source potential V_{cc}_{_{—}}_{H} and the second power source potential V_{cc}_{_{—}}_{L} that are selectively supplied through the power supply lines 32 from the drive scanning unit 50, the first power source potential V_{cc}_{_{—}}_{H} is a power source potential for supplying a drive current that drives the organic EL element 21 to the drive transistor 22. In addition, the second power source potential V_{cc}_{_{—}}_{L} is a power source potential for applying an opposing bias to the organic EL element 21.

In the organic EL display apparatus 10 with the abovementioned configuration, it is possible to use the image data processing unit 60 according to the embodiment mentioned above as the image data processing unit 60. In a display apparatus such as the organic EL display apparatus 10, the repeatability of colors differs in each display apparatus. When using the image data processing unit 60 according to the embodiment mentioned above, the set values that are stored in the storage unit (the set value storage register 661), and determine the correction values of color temperature are set for each display apparatus depending on the properties thereof. This setting is performed prior to factory shipment of the device. Since the image data processing unit 60 according to the embodiment mentioned above can perform the correction of color temperature for all gradations even when set values for all gradations are not stored in the storage unit (the set value storage register 661), in comparison with a case that stores set values for all gradations, it is possible to suppress the scale of the circuit (achieve miniaturization). As a result of this, it is possible to contribute to simplification of the overall system configuration of the organic EL display apparatus 10.

In the organic EL display apparatus 10, by adopting a configuration in which each pixel 20 of the pixel array unit 30 is formed on a semiconductor such as a silicon wafer, it is possible to realize a miniature display apparatus that is capable of being mounted in a head-mounted display or the like. In this case, the display panel 70 of FIG. 11 corresponds to for example, a silicon wafer. Further, in an organic EL display apparatus 10 that is formed by forming each pixel 20 of the pixel array unit 30 on a semiconductor, since it is possible for the image data processing unit 60 to suppress the scale of the circuit as a result of using the image data processing unit 60 according to the embodiment mentioned above as the image data processing unit 60, it is also possible to form the image data processing unit 60 on the semiconductor along with each pixel 20. In this instance, a case of adopting a configuration in which each pixel 20 of the pixel array unit 30 is formed on a semiconductor is given as an example, but the present disclosure is not limited to being formed on a semiconductor, and it is also possible to adopt a configuration in which each pixel 20 of the pixel array unit 30 is formed on an insulated body such as a glass substrate.

In the organic EL display apparatus 10, a single pixel, which is a unit that forms a color image, is for example, set as a pixel that is formed from a combination of subpixels of the three primary colors of RGB. At this time, it is possible to set a configuration in which the subpixels (pixels) are formed from a combination of organic EL elements that emit white light and color filters of RGB. As a result of this, it is possible to set the I-V properties of the light-emitting units (organic EL elements) of each pixel (subpixel) of RGB to be the same between each pixel. Therefore, when storing the set values in the storage unit (the set value storage register 661), since it is possible to set the set values commonly for each color, it is possible to achieve further miniaturization of the scale of the circuit.

However, the subpixels (pixels) are not limited to a configuration of combining organic EL elements that emit white light and color filters of RGB, and it is also possible to adopt a so-called RGB mask color-coding configuration that color-codes organic EL materials of RGB through vapor deposition using a mask. In addition, a single pixel, which is a unit that forms a color image, is also not limited to a configuration of being formed from the three subpixels RGB, and for example, it is possible to adopt a configuration in which a single pixel is formed from four subpixels of RGBW in which a subpixel that emits white (W) light is added. In this case, when performing the correction of color temperature, a process that sets the input and output properties of W, the luminous sensitivity of which is the highest (strongest), as a reference and makes the input and output properties of RGB match these input and output properties may be performed.

It is possible for the embodiments of the present disclosure to have the following configurations.

(1) An image signal processing circuit that includes a storage unit that stores a number of set values, which determine correction values for performing correction of color temperature of an input digital image signal, that is less than a number of gradations, and a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

(2) The image signal processing circuit according to (1), in which the computation unit calculates correction values of gradations for which a set value is not stored in the storage unit on the basis of a post-correction gradation value of a gradation that is in the vicinity of the gradation.

(3) The image signal processing circuit according to (2), in which the computation unit calculates correction values of gradations for which a set value is not stored in the storage unit using straight-line interpolation from a post-correction gradation value of a gradation that is in the vicinity of the gradation.

(4) The image signal processing circuit according to any one of (1) to (3), in which the set values of the gradations of a relatively low gradation portion are stored in the storage unit.

(5) The image signal processing circuit according to any one of (1) to (4), in which in a pitch between gradations for which a set value is stored in the storage unit, a low gradation side is narrower than a high gradation side.

(6) The image signal processing circuit according to any one of (1) to (5), in which, in the gradations that correct the color temperatures, there are fewer green (G) digital image signals than red (R) and blue (B) digital image signals.

(7) The image signal processing circuit according to any one of (1) to (6), in which the computation unit performs the correction of color temperature by adding a calculated correction value to a signal value of a digital image signal.

(8) An image signal processing method that includes storing a number of set values, which determine correction values for performing correction of color temperature of an input digital image signal, that is less than a number of gradations in a storage unit, and calculating correction values for performing the correction of color temperature on the basis of the set values for gradations for which a set value is stored in the storage unit, and on the basis of post-correction gradation values of gradations for which a set value is stored for gradations for which a set value is not stored in the storage unit.

(9) A display apparatus that includes a pixel array unit that is formed by arranging pixels that include light-emitting units, and an image signal processing circuit that supplies an image signal that drives the light-emitting unit of each pixel of the pixel array unit, in which the image signal processing circuit is provided with a storage unit that stores a number of set values, which determine correction values for performing correction of color temperature of an input digital image signal, that is less than a number of gradations, and a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

(10) The display apparatus according to (9), in which the light-emitting units are formed from organic electroluminescence elements.

(11) The display apparatus according to (10), in which the pixels are formed from a combination of organic electroluminescence elements that emit white light and color filters.

(12) The display apparatus according to any one of (9) to (11), in which each pixel of the pixel array unit is formed on a semiconductor.

(13) The display apparatus according to (12), in which the image signal processing circuit is formed on the semiconductor along with each pixel of the pixel array unit.

(14) The display apparatus according to any one of (9) to (13), in which the set values for determining the correction values are set for each display apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. An image signal processing circuit comprising:
a storage unit that stores a number of set values, which determine correction values for performing correction of color temperature of an input digital image signal, that is less than a number of gradations; and
a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

2. The image signal processing circuit according to claim 1,
wherein the computation unit calculates correction values of gradations for which a set value is not stored in the storage unit on the basis of a post-correction gradation value of a gradation that is in the vicinity of the gradation.

3. The image signal processing circuit according to claim 2,
wherein the computation unit calculates correction values of gradations for which a set value is not stored in the storage unit using straight-line interpolation from a post-correction gradation value of a gradation that is in the vicinity of the gradation.

4. The image signal processing circuit according to claim 1,
wherein the set values of the gradations of a relatively low gradation portion are stored in the storage unit.

5. The image signal processing circuit according to claim 1,
wherein, in a pitch between gradations for which a set value is stored in the storage unit, a low gradation side is narrower than a high gradation side.

6. The image signal processing circuit according to claim 1,
wherein, in the gradations that correct the color temperatures, there are fewer green (G) digital image signals than red (R) and blue (B) digital image signals.

7. The image signal processing circuit according to claim 1,
wherein, the computation unit performs the correction of color temperature by adding a calculated correction value to a signal value of a digital image signal.

8. An image signal processing method comprising:
storing a number of set values, which determine correction values for performing correction of color temperature of an input digital image signal, that is less than a number of gradations in a storage unit; and
calculating correction values for performing the correction of color temperature on the basis of the set values for gradations for which a set value is stored in the storage unit, and on the basis of post-correction gradation values of gradations for which a set value is stored for gradations for which a set value is not stored in the storage unit.

9. A display apparatus comprising:
a pixel array unit that is formed by arranging pixels that include light-emitting units; and
an image signal processing circuit that supplies an image signal that drives the light-emitting unit of each pixel of the pixel array unit,
wherein the image signal processing circuit is provided with
a storage unit that stores a number of set values, which determine correction values for performing correction of color temperature of an input digital image signal, that is less than a number of gradations, and
a computation unit that calculates correction values for performing the correction of color temperature on the basis of the set values for gradations for which a set value is stored in the storage unit, and on the basis of post-correction gradation values of gradations for which a set value is stored for gradations for which a set value is not stored in the storage unit.

10. The display apparatus according to claim 9,
wherein the light-emitting units are formed from organic electroluminescence elements.

11. The display apparatus according to claim 10,
wherein the pixels are formed from a combination of organic electroluminescence elements that emit white light and color filters.

12. The display apparatus according to claim 9,
wherein each pixel of the pixel array unit is formed on a semiconductor.

13. The display apparatus according to claim 12,
wherein the image signal processing circuit is formed on the semiconductor along with each pixel of the pixel array unit.

14. The display apparatus according to claim 9,
wherein the set values for determining the correction values are set for each display apparatus.
